(19) United States
(12) Patent Application Publication
(10) Pub. No.: US 2014/0351210 A1
(43) Pub. Date: Nov. 27, 2014

(54) DATA PROCESSING SYSTEM, DATA PROCESSING APPARATUS, AND STORAGE MEDIUM

(71) Applicant: SONY CORPORATION, Tokyo (JP)

(72) Inventor: Tsutomu KAWACHI, Tokyo (JP)

(73) Assignee: SONY CORPORATION, Tokyo (JP)

(21) Appl. No.: 14/279,647

(22) Filed: May 16, 2014

(30) Foreign Application Priority Data
May 23, 2013 (JP) 2013-108531

(51) Int. Cl. G06F 17/30

(52) U.S. Cl. CPC G06F 17/30575
USPC 707/623

(57) ABSTRACT

There is provided a data processing system including nodes each configured to retain data used for providing a user group with a service in units of one or more users serving as a part of the user group, and a routing manager configured to, in response to an access request to the data from the one or more users, perform routing to the nodes in which data of the one or more users is stored. The nodes include a first node for retaining master data of the one or more users, a second node for retaining slave data obtained by replicating the master data, and a third node. The muting manager further performs data movement processing involving changing the slave data retained in the second node into the master data, also replicating the slave data, and causing the third node to retain the replicated slave data as new slave data.

### CROSS REFERENCE TO RELATED APPLICATIONS

This application claims the benefit of Japanese Priority Patent Application JP 2013-108531 filed May 23, 2013, the entire contents of which are incorporated herein by reference.

### BACKGROUND

The present disclosure relates to a data processing system, a data processing apparatus, and a storage medium.

Data of each user used for providing services is generally retained as a database in a node of a server, and is also generally retained in a node as backup data for a case where a failure occurs. The backup data may be used for accepting access instead at the time of failure at the node, or for recovery of data lost due to the failure. Such an example of data backup technology is described in JP H5-61756A, for example.

### SUMMARY

However, with increase in the number of users provided with services and with increase in the amount of stored data for each user, a database expands to an immense size. When the database expands to an immense size, a load applied to a node associated with an access to the data increases, and the performance of the system may deteriorate. Further, once a failure occurs at a node, the influence of the failure reaches many users.

In light of the foregoing, it is desirable to provide a data processing system, a data processing apparatus, and storage medium, which are novel and improved, and which make it possible to perform more smoothly data processing using backup.

According to an embodiment of the present disclosure, there is provided a data processing system which includes nodes each configured to retain data used for providing a user group with a service in units of one or more users serving as a part of the user group, and a routing manager configured to, in response to an access request to the data from the one or more users, perform routing to the nodes in which data of the one or more users is stored. The nodes include a first node for retaining master data of the one or more users, a second node for retaining slave data obtained replicating the master data, and a third node. The routing manager further performs data movement processing involving changing the slave data retained in the second node into the master data, also replicating the slave data, and causing the third node to retain the replicated slave data as new slave data.

According to another embodiment of the present disclosure, there is 1.0 provided a data processing apparatus which includes a storage configured to retain slave data obtained by replicating master data used for providing one or more users with a service, and a controller configured to, when a routing manager, which performs routing in response to an access request to the master data, changes the slave data into the master data, accept access to the master data obtained by the change, also replicate the master data obtained by the change, and cause an external device to retain the replicated master data as new slave data.

According to another embodiment of the present disclosure, there is provided a non-transitory computer-readable storage medium having a program retained therein for causing a computer to achieve a function, the computer being connected to a storage retaining slave data obtained by replicating master data used for providing one or more users with a service, the function including, when a routing manager, which performs routing in response to an access request to the master data, changes the slave data into the master data, accepting access to the master data obtained by the change, also replicating the master data obtained by the change, and causing an external device to retain the replicated master data as new slave data.

The pieces of data used for providing a user group with a service are retained in separate nodes as master data and slave data in units of users, and thus, the slave data can be used as a backup in the case where the master data is not available. In this case, the master data of another user may be available continuously. Further, by causing a third node to retain new slave data, the backup can be used continuously.

According to one or more of embodiments of the present disclosure, data processing using backup can be performed more smoothly.

### BRIEF DESCRIPTION OF THE DRAWINGS

FIG. 1 is a diagram schematically showing a configuration of a data processing system according to a first embodiment of the present disclosure;

FIG. 2 is a flowchart showing an example of data access processing performed in the data processing system shown in FIG. 1;

FIG. 3 is a flowchart showing an example of replication processing performed in the data processing system shown in FIG. 1;

FIG. 4 is a diagram showing an example of user information in the data processing system shown in FIG. 1;

FIG. 5 is a diagram showing an example of node information in the data processing system shown in FIG. 1;

FIG. 6 is a diagram showing a specific example of data movement processing at a time of data access performed in the data processing system shown in FIG. 1;

FIG. 7 is a diagram showing user information updated by the data movement processing illustrated in FIG. 6.

FIG. 8 is a flowchart showing node monitoring processing performed in a data processing system according to a second embodiment of the present disclosure;

FIG. 9 is a diagram showing a specific example of data movement processing performed in the data processing system shown in FIG. 8;

FIG. 10 is a flowchart showing an example of load distribution processing performed in a data processing system according to a third embodiment of the present disclosure;

FIG. 11 is a diagram showing an example of user information according to the third embodiment of the present disclosure;

FIG. 12 is a diagram showing an example of node information according to the third embodiment of the present disclosure;

FIG. 13 is a diagram showing a specific example of load distribution processing according to the third embodiment of the present disclosure;

FIG. 14 is a diagram schematically showing a configuration of a data processing system according to another embodiment of the present disclosure;

FIG. 15 is a diagram schematically showing a configuration of a data processing system according to still another embodiment of the present disclosure; and

FIG. 16 is a block diagram illustrating a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. First embodiment
1-1. System configuration
1-2. Processing flow
1-3. Example of management information
1-4. Example of data movement processing

2. Second embodiment

3. Third embodiment

4. Other variations

5. Hardware configuration

6. Supplement

### 1. First Embodiment

### (1-1. System Configuration)

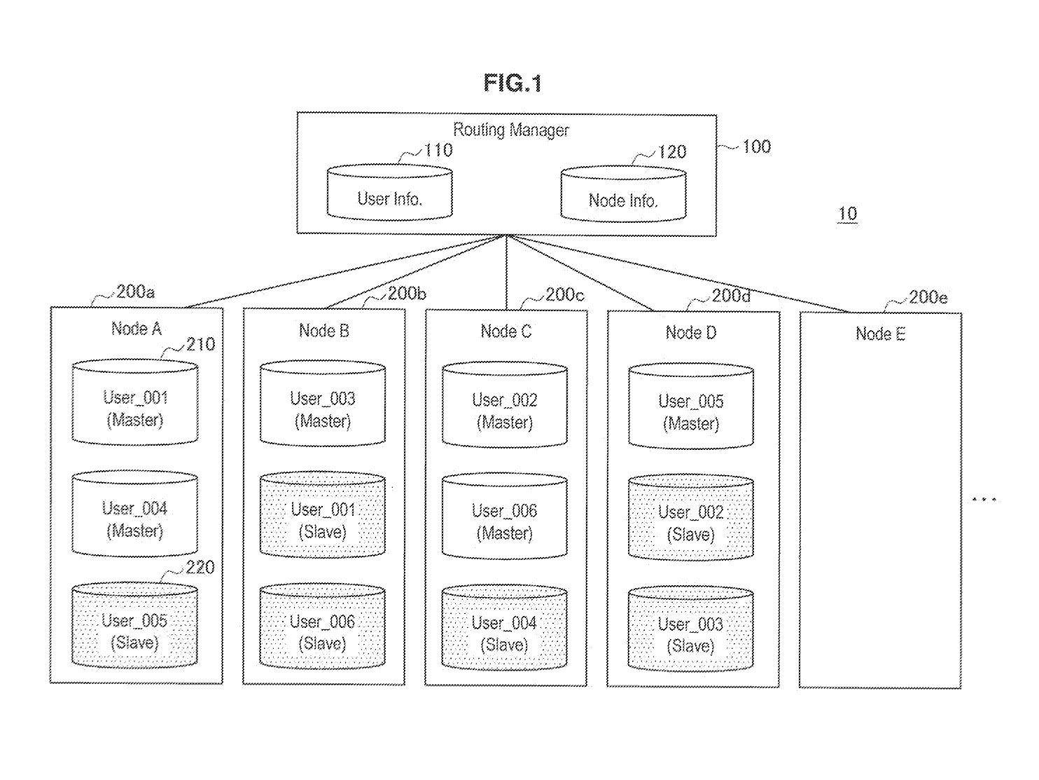

FIG. 1 is a diagram schematically showing a configuration of a data processing system according to a first embodiment of the present disclosure.

Referring to FIG. 1, a system 10 includes a routing manager 100 and nodes 200.

The routing manager 100 may be achieved with a hardware configuration of an information processing apparatus to be described later, for example. The routing manager 100 represents, for example, one or more information processing apparatuses functioning as a server in a network, and, in response to an access request to data from a user to whom a service is provided, performs routing to a node 200. As described below, in the present embodiment, data used for providing a user with a service is retained in the node 200 in units of users, the number of users being one or more (hereinafter, simply abbreviated as “user” may mean that the number of users is one or more). Accordingly, the routing manager 100 has user information 110 stored in a storage device or the like, and, referring to the user information 110, specifies which node 200 stores data of the user who has transmitted the access request. Further, the routing manager 100 monitors a status of the node 200 regularly or at a time of data access, and stores the information in the storage device or the like, as node information 120.

The node 200 may also be achieved with a hardware configuration of an information processing apparatus to be described later, for example. The node 200 is, for example, an information processing apparatus connected to the routing manager 100 via a network, and retains data used for providing a user with a service. Although the figure shows nodes 200a to 200e, the system 10 may include more nodes 200. Each node 200 may store master data 210 and slave data 220. The master data 210 is data to be accessed when providing a user with a service. The slave data 220 is data obtained by replicating the master data 210. and is used as a backup of the master data 210. As described above, in the present embodiment, data is retained in the node 200 in units of users, Accordingly, pieces of master data 210 of respective users may be retained in different nodes 200. Further, in the present embodiment, master data 210 and slave data 220 are retained in different nodes 200. In addition, there may be a standby node like the node 200e shown in the figure, which does not retain the master data 210 and the slave data. 220 at a certain time point.

### (1-2. Processing Flow)

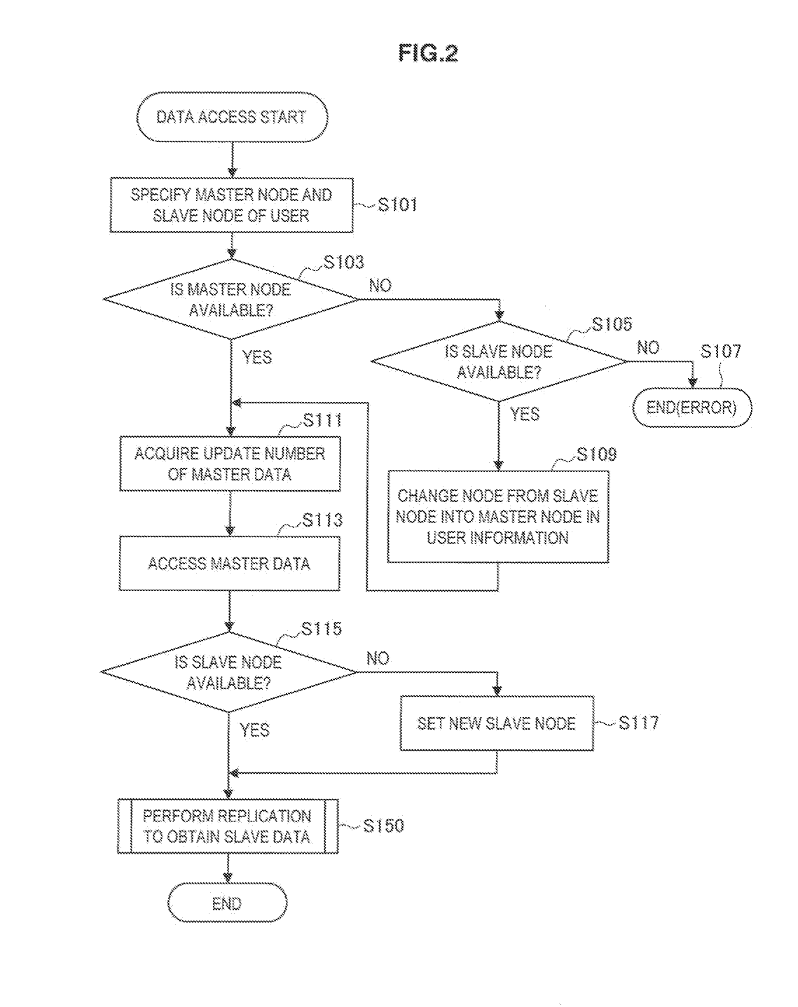

FIG. 2 is a flowchart showing an example of data access processing performed in the data processing system shown in FIG. 1. Referring to FIG. 2, first, the routing manager 100 which has received a request for data access specifies a master node and a slave node of a user (Step S101). Here, the master node represents a node retaining master data of the user, and the slave node represents a node retaining slave data of the user. The routing manager 100 specifies the master node and the slave node by referring to the user information 110. Note that specific examples of the user information 110 will be described later, Further, the processing performed by the routing manager 100 described in the present specification may be, to be specific, performed by a processor of an information processing apparatus that achieves the routing manager 100.

Next, the routing manager 100 determines whether the master node of the user is available (Step S103). Here, the routing manager 100 may refer to the node information 120, for example, and may perform determination by acquiring information indicating a state of the master node. Alternatively, the routing manager 100 may perform access to the master node, and may perform the determination on the basis of whether the access has succeeded.

In Step S103, in the case where the master node is not available (NO), the routing manager 100 performs processing of changing the master node prior to routing. Here, first, the routing manager 100 determines, in the same manner as the case of the master node in Step S103, whether the slave node of the user is available (Step S105). Here, in the case where the slave node is also not available (NO), it means that available data is temporarily not present, and thus, the processing terminates with error (Step S107).

On the other hand, in Step S105 mentioned above, in the case where the slave node is available (YES), the routing manager 100 changes the node from the slave node into the master node in the user information 110 (Step S109). Accordingly, the node 200 (slave node) that retained the slave data 220 of the user is newly registered as a node 200 (master node) retaining the master data 210 of the user, and thus, the slave data 220 till then is newly being referred to as the master data 210.

After the new master node is set by the processing of Step S105 to S109 and in the case where the master node is available in Step S103 (YES), the routing manager 100 performs routing to the master node. To be more specific, the routing manager 100 accesses the node 200 which has been defined as the master node in the user information 110, and acquires an update number of the master data 210 (Step S111). Subsequently, access b the user who has transmitted the access request to the master data is performed (Step S113). Note that the access to the master data may include addition, update, duplication, or deletion of data.

When the access to the master data (Step S113) is terminated, the routing manager 100 determines, in the same manner as the case of the master node in Step S103, whether the slave node of the user is available (Step S115). Here, in the case where the slave node is not available (NO), the routing manager 100 sets a new slave node (Step S117). The slave node is selected from nodes 200 other than the master node, for example. The selected slave node is registered in the user information 110.

Note that there are the following two cases in which the new slave node is set in Step S117. One is the case where, since the master node has been available (YES in Step S103), the access to the master data has been performed, but on the other hand the slave node is not available. The other is the case where, since the master node has not been available (NO in Step S103), the slave node has been changed into the master node in Step S109, and hence, the slave node is not present. With the determination performed in Step S115 and the processing performed in Step S117, a slave node is newly set that is available for the both cases.

Next, the routing manager 100 performs replication from the master data. to obtain the slave data (Step S150). In this way, the result of data access in Step S113 is reflected in the slave data, and a status in which the master data is synchronized with the slave data is obtained.

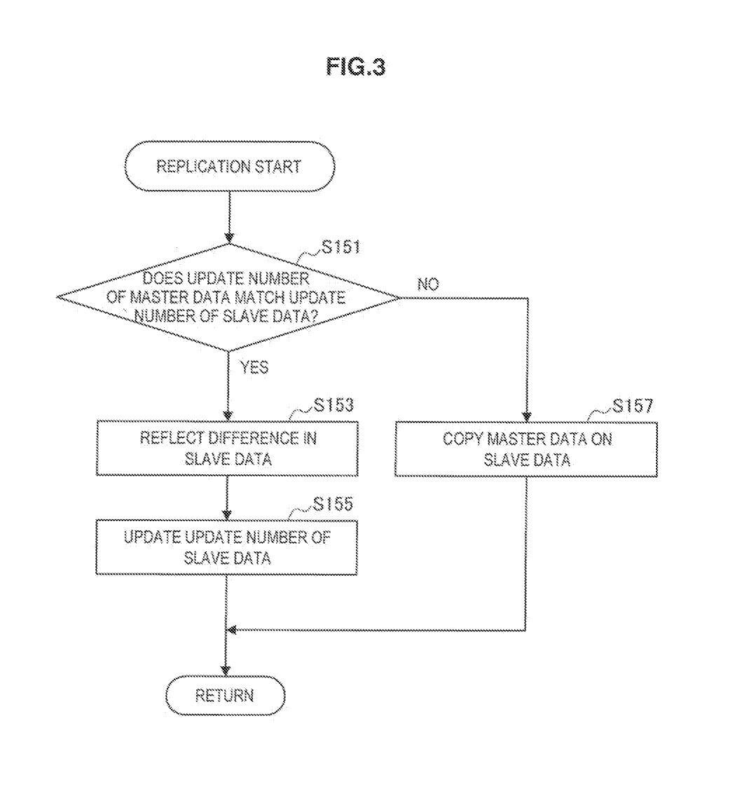

FIG. 3 is a flowchart showing an example of replication processing performed in the data processing system shown in FIG. 1. Note that the replication processing described here corresponds to the processing of Step S150 shown in FIG. 2. Referring to FIG. 3, the routing manager 100 performing the replication determines whether the update number of the master data matches the update number of the slave data (Step S151). Here, if the update number of the master data matches the update number of the slave data (YES), the routing manager 100 reflects the difference between the master data and the slave data in the slave data (Step S153), and updates the update number of the slave data (Step S155). On the other hand, if, in Step S151, the update number of the master data does not match the update number of the slave data (NO), the routing manager 100 copies the master data on the slave data (Step S157).

### (1-3. Example of Management Information)

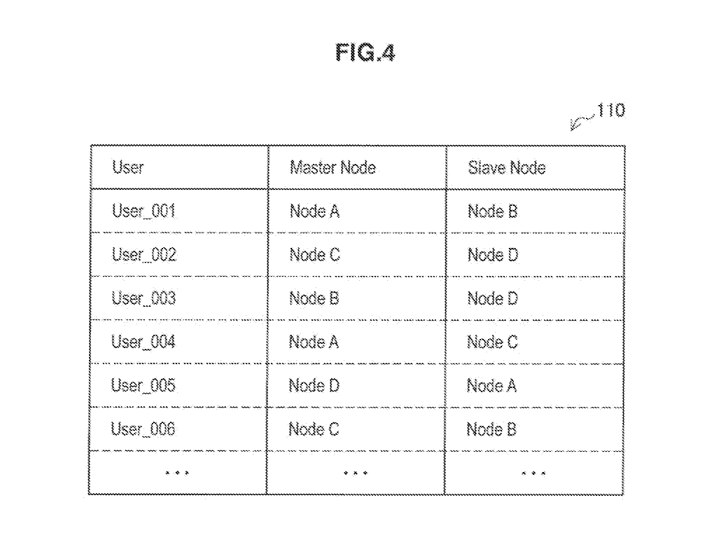

FIG. 4 is a diagram showing an example of user information in the data processing system shown in FIG. 1. Referring to FIG. 4, the user information 110 includes the items of “user” “master node”, and “slave node”. The “user” is information used for identifying a user to be a target of routing performed by the routing manager 100. The “master node” and the “slave node” are pieces of information representing nodes 200 retaining master data and slave data of the user specified as the “user”, respectively. Although the names of the nodes (Node A, Node B, . . . ) are recorded in the example shown in the figure, addresses may also be recorded instead of the name, the addresses being for identifying the respective nodes 200 in a network.

Note that the “user” in the user information 110 means one or more users, each of the users being served as a unit of data retention in a node 200, and does not necessarily correspond to an individual user account for using a service. For example, an ID of “User_001” written in the item of “user” may correspond to multiple user accounts. In this case, the user information 110 defines that master data of the multiple user accounts is retained in Node A (node 200a) serving as the “master node”, and that slave data of the multiple user accounts is retained in Node B (node 200b) serving as the “slave node”. In the case where there are data access requests from the user accounts, the routing manager 100 performs routing to Node A. Which record to access among the pieces of master data stored in Node A may be determined in Node A depending on a query included in the access request, for example.

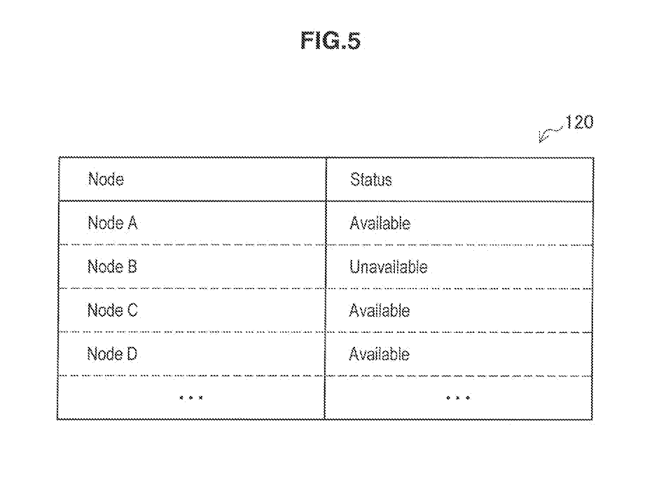

FIG. 5 is a diagram showing an example of node information in the data processing system shown in FIG. 1. Referring to FIG. 5, the node information 120 includes the items of “node” and “status ”, The “node” is information used for identifying with each other a node 200 to be a target of routing performed by the routing manager 100. As already described for the user information 110, each node 200 may not be recorded in a name of the node, but may be recorded in an address. The “status” is information indicating whether each node is available, In the example shown in the figure, it is shown that Node B (node 200b) is not available. The information of the “status” may be updated by the routing manager 100 regularly monitoring the status of the node 200, for example, or may be updated on the basis of success or failure of the access at the time of performing the data access as shown in FIG. 2.

### (1-4. Example of Data Movement Processing)

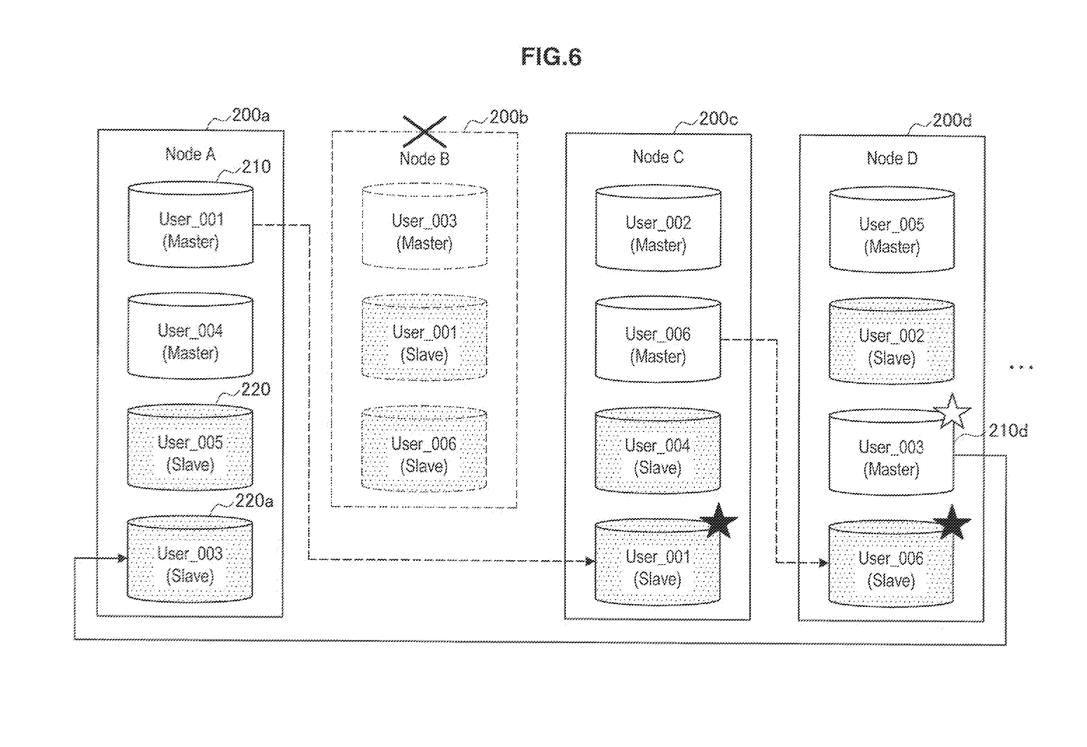

FIG. 6 is a diagram showing a specific example of data movement processing at a time of data access performed in the data processing system shown in FIG. 1. FIG. 6 shows data movement processing in the case where the node 200b (Node B) is not available due to device failure, communication error, or the like. Here, the node 200b retains master data 210 of User_003, slave data 220 of User_001, and slave data 220 of User_006.

For example, the routing manager 100, which has received a data access request from User_003 (that is, any one of one or more user accounts identified as User_003), attempts to access the node 200b serving as a master node in accordance with the user information 110 as illustrated in FIG. 4, but, as shown in the node information 120 illustrated in FIG. 5, the node 200b is not available.

Consequently, the routing manager 100 further refers to the user information 110, and changes the slave data 220 (shown with a white star in the figure) of User_003 retained in the node 200d (Node D) serving as a slave node into master data 210d. The routing manager 100 performs routing to the node 200d retaining the new master data 210d in response to the access request from User_003, and thus, the access to the master data 210d is performed.

At this point, as for User_003, there is no slave data since the original slave data 220 has changed into the master data 210d. Accordingly, the routing manager 100 replicates the master data 210d of the node 200d, and causes the node 200a to retain the replicated master data 210d as new slave data 220a Note that the node 200 for retaining new slave data 220 may be selected from available nodes 200 (nodes 200a and 200c in the example illustrated in the figure) that is other than the node 200d which already retains the master data 210d. At this point, if the node 200b is recovered, the node 200b may be added to the group of nodes from which node for retaining the slave data 220 is selected from, or the node 200b may also be selected preferentially as a node for retaining the slave data 220.

On the other hand, as for each of User_001 and User_006, since it is slave data 220 that is retained in the node 200b, each of User_001 and User_006 is capable of accessing master data 210 retained in another node 200 (node 200a for User_001 and node 200c for User_006). However, for example, it becomes difficult to access data in the case where device failure, communication error, or the like occurs to other nodes. Accordingly; for example, as shown in Step S115 of FIG. 2, it is determined whether the node 200 retaining the slave data 220 is available at a timing of accessing the master data 210, and, if the node 200 is not available, new slave data 220 is created in another node.

In the example illustrated in the figure, new slave data 220 (shown with a black star in the figure) is created in each of the node 200c (Node C) for User_001 and the node 200d (Node D) for User_006. Those pieces of slave data 220 are generated by replicating the pieces of master data 210 retained in other nodes. Note that a new node 200 retaining new slave data 220 may be selected from available nodes 200 that is other than the node 200 which already retains the master data 210, for example. Accordingly, as for User_001, the nodes 200c and 200d are options for the new slave node, and as for User_006, the nodes 200a and 200d are options for the new slave node. In the same manner as the case of User_003, if the node 200b has recovered, the node 200b may be added to the options.

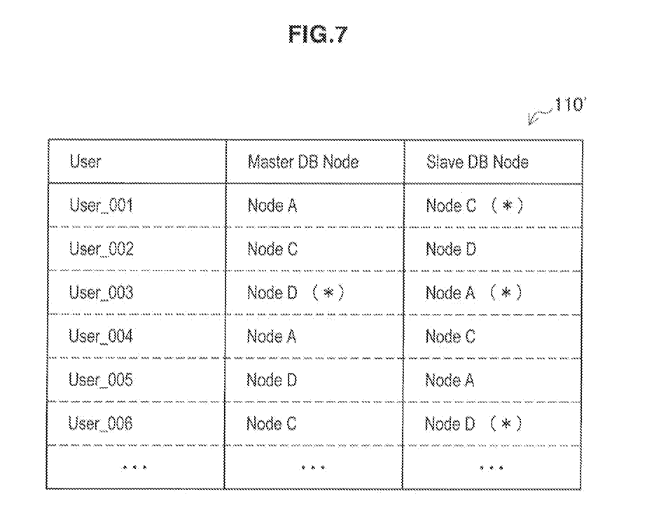

FIG. 7 is a diagram showing user information updated by the data movement processing illustrated in FIG. 6. In FIG. 7, the mark “(*)” is attached to the updated items, for convenience of the description. in user information 110′ illustrated in the figure, as for User_001 and User_006, only slave nodes are changed. Further, as for User_003, both master and slave nodes are changed. Accordingly, Node B (node 200b), which is not available, is not serving as a master node and as a slave node in any user.

Heretofore, the first embodiment of the present disclosure has been described. In the present embodiment, when pieces of data used for providing users with services are retained dispersedly in nodes in units of one or more users and routing is performed in response to an access request to data from a user, in the case where a failure has been found in a master node to be subjected to the routing, alternative routing to a slave node retaining the replicated data is performed. In this way, even if there has been a failure in the master node, services can be continually provided to the users.

Further, in the present embodiment, since the pieces of data are retained dispersedly in nodes in units of users, the target to be subjected to the alternative routing can be limited to the users each having the node as a master node or as a slave node. In the case where all pieces of data for all users are retained collectively, the switching from a slave node to a master node or the setting of a new slave node influences all users, but in the present embodiment, the influence can be limited to users in a smaller range. Further, for example, by performing data movement processing when a failure occurs at a time of data access as the example described above, a user who did not transmit a data access request during the failure may be capable of performing the same routing as before after the failure recovery.

### 2. Second Embodiment

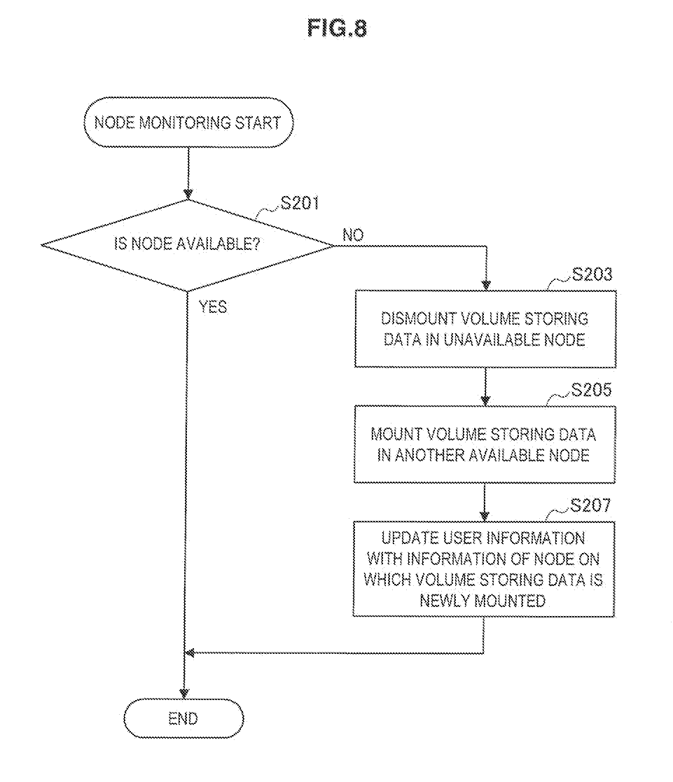

FIG. 8 is a flowchart showing node monitoring processing performed in a data processing system according to a second embodiment of the present disclosure. In the present embodiment, in a similar data processing system as the data processing system of the first embodiment, regular node states monitoring is performed in addition to at the time of data access or separately from at the time of data access, and in the case where a node that is not available is found, data movement processing is performed. Note that, as for parts other than the parts to be described below, the configuration of the present embodiment may be the same as the configuration of the first embodiment.

Referring o FIG. 8, first, a routing manager 100 performing node monitoring determines whether a node is available for each node 200 (Step S201), Here, in the case where a node 200 is available (YES), the processing with respect to the node 200 is terminated. On the other hand, in the case where a node 200 is not available (NO), the routing manager 100 dismounts a volume storing data in the unavailable node 200 (Step S203). In addition, the routing manager 100 mounts the volume dismounted in Step S203 on another available node 200, for example, on a standby node (Step S205). Then, the routing manager 100 updates the user information 110 with information of the node 200 on which the volume is newly mounted (Step S207).

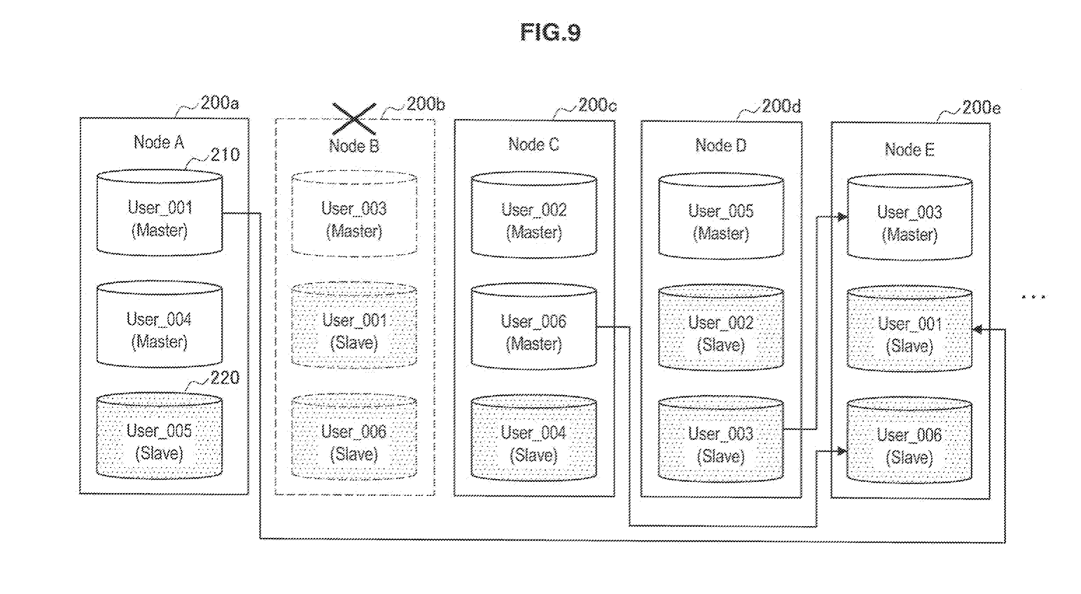

FIG. 9 is a diagram showing a specific example of data movement processing performed in the data processing system shown in FIG. 8. FIG. 9 shows, in the system 10 shown in FIG. 1 used for the description of the first embodiment, data movement processing in the case where the node 200b (Node B) becomes not available due to device failure, communication error, or the like. Here, the node 200b retains master data 210 of User_003, slave data 220 of User_001 and slave data 220 of User_006.

When the routing manager 100 performing node monitoring finds that the node 200b is not available, the routing manager 100 dismounts a volume storing data in the node 200b, and mounts the volume on a standby node 200e (Node E). Accordingly, the node 200e newly retains the master data 210 of User_003, the slave data 220 of User_001, and the slave data 220 of User_006. In this case, the master data 210 of User_003 may be generated by replicating the slave data 220 stored in the node 200d. Further, the slave data 220 of User_001 and the slave data 220 of User_006 may be generated by replicating pieces of master data. 210 stored in the nodes 200a and 200c, respectively.

In this case, in order to prevent from occurring the status in which there is no master data 210 of User_003 during the data movement processing, the slave data 220 stored in the node 200d may be changed into the master data 210 first, and then the slave data 220 of User_003 may be created in the node 200e. Note that, from the viewpoint of load distribution for example, in the case where it is desirable to disperse pieces of master data, the slave data 220 of User_003 in the node 200e may changed into the master data 210 and the master data 210 of the User_003 in the node 200d may be returned into the slave data 220 after completion of data replication.

Heretofore, the second embodiment of the present disclosure has been described. In the present embodiment, in the case where a failure is found in a node by monitoring the node regularly even if there is no data access request, the master data and the slave data retained in the node are moved to another node such as a standby node. Since the data is retained in units of users, a user whose master data is retained in a node other than the above node can be provided continually with services even during the data movement processing. Thus, in the case where there is a data access request, it is highly likely that it becomes possible to perform routing to an available master node.

### 3. Third Embodiment

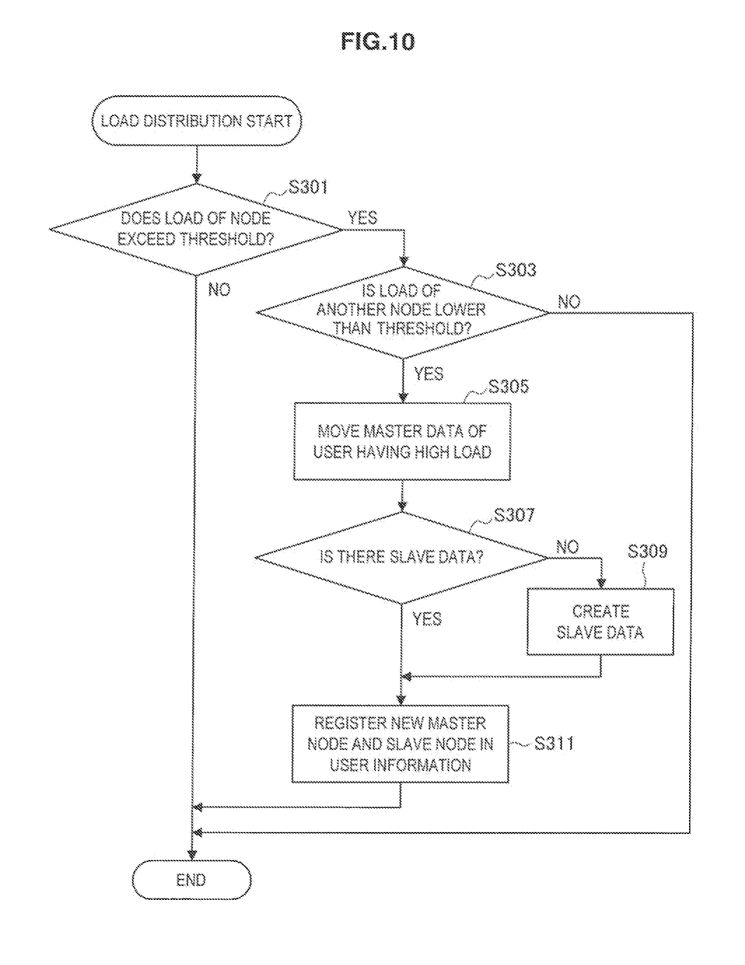

FIG. 10 is a flowchart showing an example of load distribution processing performed in a data processing system according to a third embodiment of the present disclosure. In the present embodiment, in a similar data processing system as the data processing systems of the first and second embodiments, data movement processing for load distribution is performed in addition to at the time of data access and/or at the time of node monitoring, or separately from those. Note that, as for parts other than the parts to be described below, the configuration of the present embodiment may be the same as the configuration of the first or second embodiment.

Referring to FIG. 10, the routing manager 100 refers to node information 122 to be described later, and determines whether a load of each node 200 exceeds a given threshold (Step S301). Here, in the case where there is no node 200 having a load exceeding the threshold (NO), the load distribution processing is terminated. On the other hand, in the case there is a node 200 having a load exceeding the threshold (YES), the routing manager 100 determines whether there is another node 200 having a load lower than a threshold (Step S303). Note that the threshold used in Step S303 may be the same value as the threshold used in Step S301, for example, or may be a value smaller than the threshold used in Step S301. In the case where there is no node having a load lower than the threshold in Step S303 (NO), that is, in the case where all nodes are in high load statuses, the load distribution processing is terminated since there is no distribution destination. Alternatively, a threshold having a higher value may be set and the determinations of Steps S301 and S303 may be repeated.

In the case where there is another node 200 having a load lower than the threshold in Step S303, that is, one node 200 has a load exceeding a threshold and another node 200 has a load lower than a threshold, the routing manager 100 performs the data movement processing. To be specific, the routing manager 100 moves master data of a user having a load higher by a given degree or more among the users whose pieces of master data are retained in a node 200 (hereinafter, also referred to as high load node) having a load exceeding a threshold, to a node 200 (hereinafter, also referred to as low load node) having aloud lower than a threshold (Step S305). Here, the low load node may be a node having the lowest load among the nodes 200 each having a load lower than a threshold, for example. Further, the low load node may be selected from nodes which do not retain the slave data of a user of the movement target out of the nodes 200 each having a load lower than a threshold.

Here, the user of the movement target may be, for example, a user whose access frequency to master data is higher and applies larger loads to the node. Further, the user to be the movement target may be a user having the largest load among the users whose pieces of master data are retained in the high load node. However, for example, in the case where most of the load of the high load node is generated by the user, and thus, it is predicted that the load of the low load node of the movement destination exceeds a threshold if the master data of that user is moved, master data of a user having a load whose size is second and below may be moved or the movement of master data itself may be discontinued. Note that the node of the movement destination may be the above-mentioned standby node.

Further, when the slave data of the target user is already retained in the low load node of the movement destination, for example, the data movement in Step S305 may be performed by changing the slave data into master data. On the other hand, in the case where the low load node of the movement destination is different from the node retaining the slave data of the target user, new master data may be created in the low load node by replicating the master data retained in the high load node, In this case, since the slave data is already retained in another node, the original master data retained in the high load node may be deleted, or the original master data. retained in the high load node may be changed into the slave data and the slave data retained in another node may be deleted.

Next, the routing manager 100 determines whether there is slave data of the user whose master data has been moved (Step S307). the case where it is determined that there is no slave data (NO) represents the case where the low load node of the movement destination in Step S305 already retains the slave data of the target user and the data movement is performed by changing the slave data into the master data, for example. In such a case, the routing manager 100 newly creates slave data (Step S309). The processing may be performed by, for example, changing the original master data retained in the high load node of the movement source into the slave data. Alternatively, new slave data may be created by replicating the master data in another node different from the high load node of the movement source and different from the low load node of the movement destination.

Note that the slave data created in Step S309 is the data. of the user which have a high load and hence have become the movement target. As described above, since the slave data may be used by being changed into master data, in creating the slave data, a node having a lower load at that point may be selected.

When the slave data is already present (YES in Step S307) or is newly created (Step S309), the routing manager 100 registers information of a new master node and a new slave node in user information 112 to be described later (Step S311).

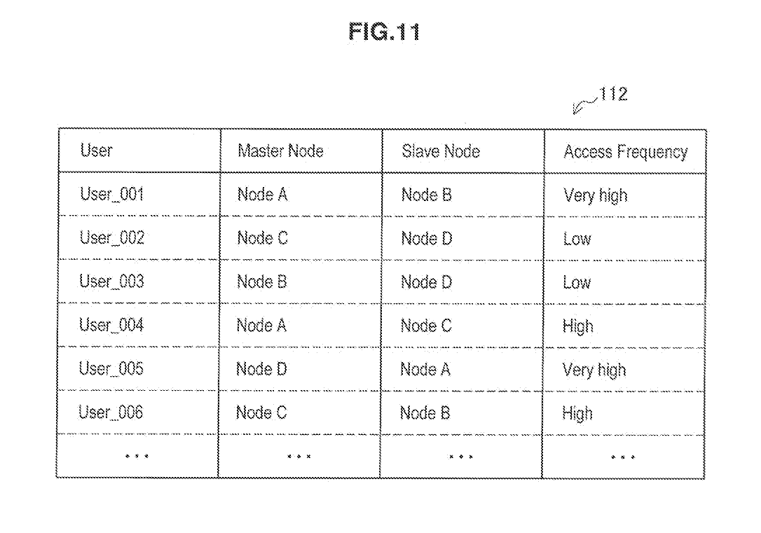

FIG. 11 is a diagram showing an example of user information according to the third embodiment of the present disclosure. Referring to FIG. 11, in addition to the items of the user information 110 described with reference to FIG, 4, the user information 112 includes the item of “access frequency”. The “access frequency” is information indicating how often a user has accessed master data. With increase in the access frequency, it is assumed that the user applies a larger load on the node 200 in which the master data is retained. In the load distribution processing described with reference to FIG. 10, the routing manager 100 may refer to the item of “access frequency” and may specify a user having a load higher by a given degree or more among the users whose master data is retained in a high load node. Note that, as shown in the figure, for example, the “access frequency” may be recorded in grades such as “very high”, “high”, and “low”, or may be recorded in numerical values such as the number of accesses per day.

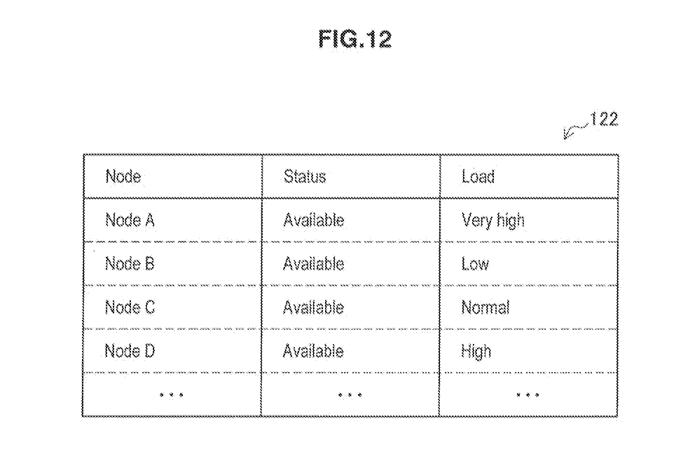

FIG. 12 is a diagram showing an example of node information according to the third embodiment of the present disclosure. Referring to FIG. 12, in addition to the items of the node information 120 described with reference to FIG. 5, the node information 122 includes the item of “load”. The “load” is information indicating how much load is applied to anode. In the load distribution processing described with reference to FIG. 10, the routing manager 100 may refer to the item of “load” and may determine whether a load applied to a node 200 exceeds a threshold. Note that, as shown in the figure, for example, the “load” may be recorded in grades such as “very high”, “high”, and “low”, or may be recorded in index values including processor or memory usage, and load averages.

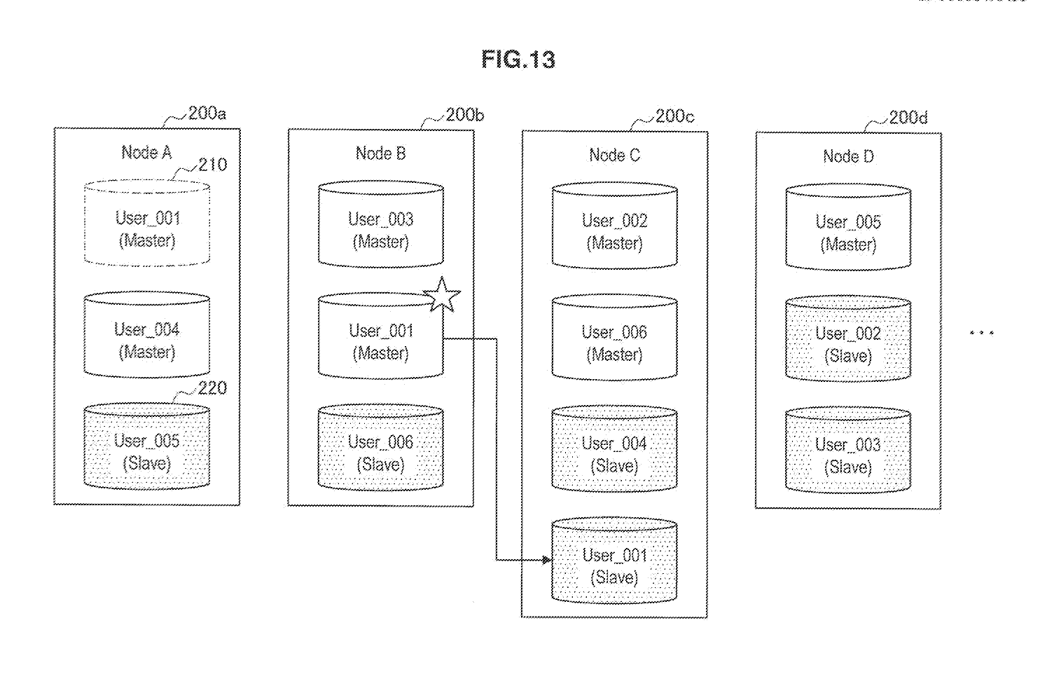

FIG. 13 is a diagram showing a specific example of load distribution processing according to the third embodiment of the present disclosure. FIG. 13 shows load distribution processing in the case where the access frequency of each user and the load of each node 200 as illustrated in FIG. 11 and FIG. 12 have occurred in the system 10 shown in FIG 1 described in the first embodiment.

In the example illustrated in the figure, as in the node information 122 shown in FIG. 12, the node 200a (Node A) has the highest load. In this case, if the load of the node 200a exceeds a given threshold, the routing manager 100 performs data movement processing of moving data from the node 200a to another node. On the other hand, according to the node information 122, the node 200b (Node B) has the lowest load. Consequently, the routing manager 100 decides that the node 200b is to be the data movement destination. Accordingly, in the example above, the node 200a is handled as a high load node, and the node 200b is handled as a low load node.

Here, as in the user information 112 shown in FIG. 11, among the users whose pieces of master data 210 are retained in the node 200a, the access frequency of User_001 is “very high” and the access frequency of User_004 is “high”. Here, the routing manager 100 decides that User_001 having higher access frequency is to be the user of the movement target, and performs the data movement processing. Here, since the node 200b already maintains the slave data 220 of User_001, the routing manager 100 changes the slave data 220 (shown with a white star in the figure) into the master data 210.

In addition, since the slave data of User_001 disappears by the above processing, the routing manager 100 newly creates the slave data 220 of User_001 in the node 200c. The slave data 220 may be replicated from data of the new master data 210 in the node 200b as shown in the figure, for example, or may be replicated from the original master data 210 retained in the node 200a Note that, in the case of the example shown in the figure, the original master data 210 retained in the node 200a may be deleted after the data movement processing is terminated.

Heretofore, the third embodiment of the present disclosure has been described. In the present embodiment, even though no failure occurs in nodes, data movement is performed when a load of a node is high, in order to disperse the load. Such processing can be performed, because pieces of data are stored dispersedly in each node in units of users. To the users other than the user of the movement target, services can be continually provided, and, also for the user of the movement target, the service outage duration can be minimized by performing data movement processing using slave data, for example. In this way, load concentration on a part of the nodes can be reduced, and hence, the occurrence of failure and degradation in service quality due to an overload to a node can be prevented.

### (4. Other Variations)

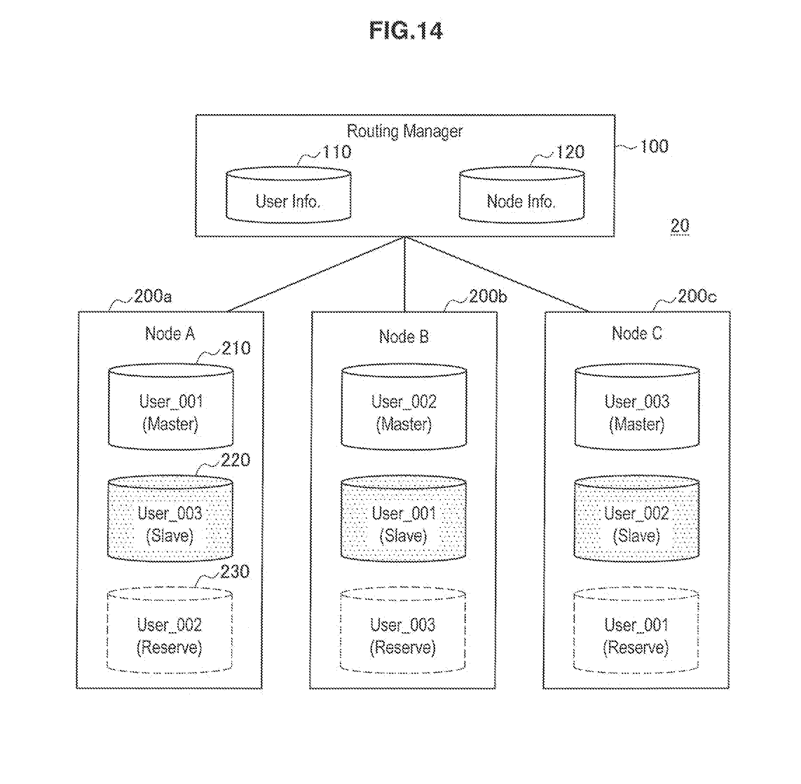

FIG. 14 is a diagram schematically showing a configuration of a data processing system according to another embodiment of the present disclosure. Referring to FIG. 14, a system 20 includes a routing manager 100 and nodes 200. Here, the routing manager 100 and the nodes 200 are the same as those included in the system 10 illustrated in FIG. 1 described in the first embodiment. The system 20 is one of the examples that achieves a data processing system according to an embodiment of the present disclosure with a minimum number of nodes 200.

The system 20 includes three nodes, that is, a node 200a, a node 200b, and a node 200c. The system 20 retains data of three groups of users (one or more users organized for retaining data), that is, User_001, User_002, and User_003. As for User_001, the node 200a retains the master data 210 and the node 200b retains the slave data 220. At this point, the node 200c does not have data of User_001, and functions as a standby node. As shown in the figure, the node 200c may keep a data retention area 230 for replication of the master data or the slave data of User_001.

In the same manner, as for User_002, the node 200b retains the master data 210, the node 200c retains the slave data 220, and the node 200a functions as a standby node. Further, as for User_003, the node 200c retains the master data 210, the node 200a retains the slave data 220, and the node 200b functions as a standby node. In this way, when there are three nodes 200, one of them is caused to function as a master node, another as a slave node, and the rest as a standby node, and thus, the data movement processing as described above can be performed. Further, in this case, when the users are divided into three groups (User_001, User_002, and User_003 in the example above) and the respective pieces of master data are retained dispersedly in different nodes 200, the loads generated by accessing master data can be dispersed.

Of course, as described in the first embodiment, it is also possible for the system to include more nodes 200 or for the nodes 200 to include node(s) each functioning as a standby node for any users, and thus to construct a system having more redundancy.

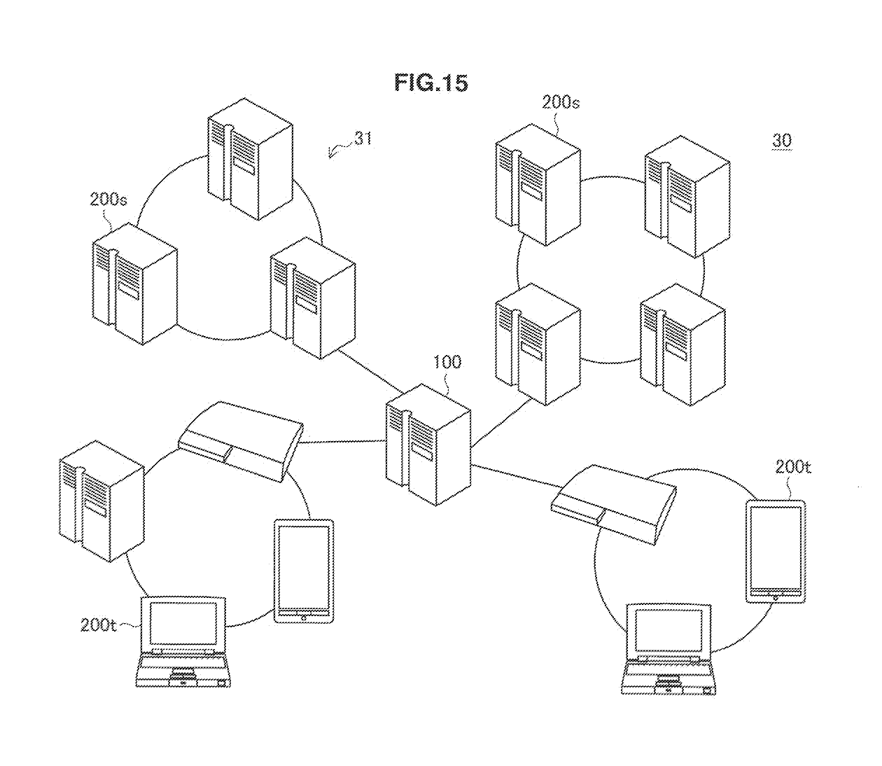

FIG. 15 is a diagram schematically showing a configuration of a data processing system according to still another embodiment of the present disclosure. Referring to FIG. 15, in a system 30, a node group 31 is formed from three or more nodes 200, and a routing manager 100 selects one of multiple node groups 31 and performs routing. The node groups 31 may be used for retaining pieces of data whose types are different from each other. For example, one node group 31 may retain data of profile information of each user, and another node group 31 may retain data of activity logs of each user. In accordance with which type of data an access request is aimed at, the routing manager 100 performs routing to a node 200 included in an appropriate node group 31.

Further, as shown in the figure, the node 200 may include a server device 200s, and may include a client device 200t. Here, the server device 200s is an information processing apparatus that exists on a network, and is solely used for providing other devices with services. On the other hand, the client device 200t is a terminal device held by a user, for example. The client device 200t functions as an interface for the user to use a service provided by the server device 200s, and, in addition, is also a device that may also be used for providing a service to the user himself/herself or to another device. The node 200 according to the present embodiment may be any one of the server device 200s and the client device 200t. This means that pieces of data of users may be stored dispersedly in the server device 200s and the client device 200t.

### (5. Hardware Configuration)

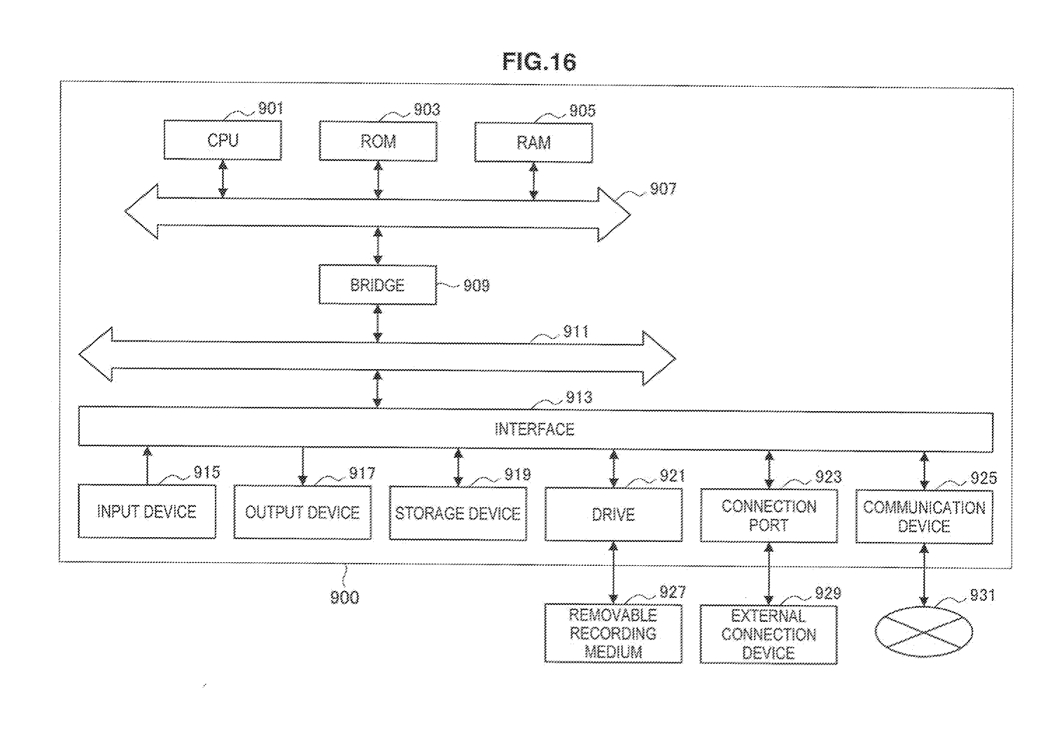

Next, with reference to FIG. 16, a hardware configuration of an information processing apparatus according to an embodiment of the present disclosure will be described. FIG. 16 is a block diagram illustrating a hardware configuration of an information processing apparatus. An information processing apparatus 900 may achieve a routing manager and a node of the embodiments described above, for example

The information processing apparatus 900 includes a central processing unit (CPU) 901, read only memory (ROM) 903, and random access memory (RAM) 905. Further, the information processing apparatus 900 may also include a host bus 907, a bridge 909, an external bus 911, an interface 913, an input device 915, an output device 917, a storage device 919, a drive 921, a connection port 923, and a communication device 925. The information processing apparatus 900 may also include, instead of or along with the CPU 901, a processing circuit such as a digital signal processor (DSP) or an application specific integrated circuit (ASIC).

The CPU 901 functions as an arithmetic processing unit and a control unit and controls an entire operation or a part of the operation of the information processing apparatus 900 according to various programs recorded in the ROM 903, the RAM 905, the storage device 919, or a removable recording medium 927. The ROM 903 stores programs and arithmetic parameters used by the CPU 901. The RAM 905 primarily stores programs used in execution of the CPU 901 and parameters and the like varying as appropriate during the execution. The CPU 901, the ROM 903, and the RAM 905 are connected to each other via the host bus 907 configured from an internal bus such as a CPU bus or the like. In addition, the host bus 907 is connected to the external bus 911 such as a peripheral component interconnect/interface (PCI) bus via the bridge 909.

The input device 915 is a device operated by a user, such as a mouse, a keyboard, a touch panel, buttons, a switch, and a lever. Also, the input device 915 may be a remote control device using, for example, infrared light or other radio waves, or may be an external connection device 929 such as a mobile phone compatible with the operation of the information processing apparatus 900. The input device 915 includes an input control circuit that generates an input signal on the basis of information input by the user and outputs the input signal to the CPU 901. The user inputs various kinds of data to the information processing apparatus 900 and instructs the information processing apparatus 900 to perform a processing operation by operating the input device 915.

The output device 917 is configured from a device capable of visually or aurally notifying the user of acquired information. For example, the output device 917 may be: a display device such as a liquid crystal display (LCD), a plasma display panel (PDP), or an organic electro-luminescence (EL) display; an audio output device such as a speaker and headphones; or a printer. The output device 917 outputs results obtained by the processing performed by the information processing apparatus 900 as video in the form of text or an image or as audio in the form of audio or sound.

The storage device 919 is a device for storing data configured as an example of a storage of the information processing apparatus 900. The storage device 919 is configured from, for example, a magnetic storage device such as a hard disk drive (HDD), a semiconductor storage device, an optical storage device, or a magneto-optical storage device. This storage device 919 stores programs to be executed by the CPU 901, various data, and various data obtained from the outside.

The drive 921 is a reader/writer for the removable recording medium 927 such as a magnetic disk, an optical disc, a magneto-optical disk, or a semiconductor memory, and is built in or externally attached to the information processing apparatus 900. The drive 921 reads out information recorded on the attached removable recording medium 927, and outputs the information to the RAM 905. Further, the drive 921 writes the record on the attached removable recording medium 927.

The connection port 923 is a port for allowing devices to directly connect to the information processing apparatus 900. Examples of the connection port 923 include a universal serial bus (USB) port, an IEEE1394 port, and a small computer system interface (SCSI) port. Other examples of the connection port 923 may include an RS-232C port, an optical audio terminal, and a high-definition multimedia interface (HDMI (registered trademark)) port. The connection of the external connection device 929 to the connection port 923 may enable the various data exchange between the information processing apparatus 900 and the external connection device 929.

The communication device 925 is a communication interface configured from, for example, a communication device for establishing a connection to a communication network 931. The communication device 925 is, for example, a wired or wireless local area network (LAN), Bluetooth (registered trademark), a communication card for wireless USB (WUSB), or the like. Alternatively, the communication device 925 may be a router for optical communication, a router for asymmetric digital subscriber line (ADSL), a modem for various communications, or the like. The communication device 925 can transmit and receive signals and the like using a given protocol such as TCP/IP on the Internet and with other communication devices, for example. The communication network 931 connected to the communication device 925 is configured from a network and the like, which is connected via wire or wirelessly, and is, for example, the Internet, a home-use LAN, infrared communication, radio wave communication, and satellite communication.

Heretofore, an example of the hardware configuration of the information processing apparatus 900 has been shown. Each of the structural elements described above may be configured using a general-purpose material, or may be configured from hardware dedicated to the function of each structural element. The configuration may be changed as appropriate according to the technical level at the time of carrying out embodiments.

### (6. Supplement)

The embodiments of the present disclosure may include the information processing apparatus (routing manager or node), the system, the information processing method performed in the information processing apparatus or the system, the program for causing the information processing apparatus to function, and the non-transitory tangible media having the program recorded thereon, which have been described above, for example.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A data processing system including:

nodes each configured to retain data used for providing a user group with a service in units of one or more users serving as a part of the user group; and

a routing manager configured to, in response to an access request to the data from the one or more users, perform routing to the nodes in which data of the one or more users is stored,

wherein the nodes include a first node for retaining master data of the one or more users, a second node for retaining slave data obtained by replicating the master data, and a third node, and

wherein the routing manager further performs data movement processing involving changing the slave data retained in the second node into the master data, also replicating the slave data, and causing the third node to retain the replicated slave data as new slave data.

(2) The data processing system according to (1),

wherein the routing manager performs the data movement processing in a case where the first node is not available.

(3) The data processing system according to (2),

wherein, in a case where routing to the first node is not performed in response to an access request from the one or more users, the routing manager performs alternative routing to the second node and also performs the data movement processing.

(4) The data processing system according to (3),

wherein, in a case where the routing to the first node is performed in response to an access request from the one or more users, the routing manager inspects the second node, and in a case where it is found by the inspection that the second node is not available, the routing manager performs processing involving replicating the master data retained in the first node and causing the third node to retain the replicated master data as new slave data.

(5) The data processing system according to any one of (2) to (4),

wherein the routing manager finds that the first node is not available by regularly inspecting the nodes.

(6) The data processing system according to any one of (1) to (5),

wherein the routing manager performs the data movement processing in accordance with loads which the one or more users apply to the nodes.

(7) The data processing system according to (6),

wherein the routing manager performs the data movement processing in a case where a load applied to the first node is higher than a load applied to the second node.

(8) The data processing system according to any one of (1) to (7),

wherein, for another one or more users different from the one or more users, the first node retains the slave data.

(9) The data processing system according to any one of (1) to (8),

wherein, for another one or more users different from the one or more users, the second node retains the master data.

(10) The data processing system according to any one of (1) to (9),

wherein, for another one or more users different from the one or more users, the third node retains the master data or the slave data.

(11) The data processing system according to any one of (1) to (10),

wherein the third node is selected from the nodes during the data movement processing.

(12) The data processing system according to any one of (1) to (11),

wherein the first node, the second node, and the third node form a node group,

wherein the data processing system includes a plurality of the node groups for retaining a plurality of types of the data, and

wherein the routing manager performs routing by selecting any one of the plurality of node groups in accordance with a type of the data.

(13) The data processing system according to any one of (1) to (12),

wherein the nodes include a server device.

(14) The data processing system according to any one of (1) to (13),

wherein the nodes include a client device.

(15) A data processing apparatus including:

a storage configured to retain slave data obtained replicating master data used for providing one or more users with a service; and

a controller configured to, when a routing manager, which performs routing in response to an access request to the master data, changes the slave data into the master data, accept access to the master data obtained by the change, also replicate the master data obtained by the change, and cause an external device to retain the replicated master data as new slave data.

(16) The data. processing apparatus according to (15),

wherein, for another one or more users different from the one or more users, the storage retains the master data.

(17) The data processing apparatus according to (15),

wherein. for another one or more users different from the one or more users, the storage does not retain the master data and does not retain the slave data.

(18) The data processing apparatus according to any one of (15) to (17),

wherein the data processing apparatus is a server device.

(19) The data processing apparatus according to any one of (15) to 17),

wherein the data processing apparatus is a client device.

(20) A non-transitory computer-readable storage medium having a program retained therein for causing a computer to achieve a function, the computer being connected to a storage retaining slave data obtained by replicating master data used for providing one or more users with a service,

the function including, when a routing manager, which performs routing in response to an access request to the master data, changes the slave data into the master data, accepting access to the master data obtained by the change, also replicating the master data obtained by the change, and causing an external device to retain the replicated master data as new slave data.

What is claimed is:

1. A data processing system comprising:
nodes each configured to retain data used for providing a user group with a service in units of one or more users serving as a part of the user group; and
a routing manager configured to, in response to an access request to the data from the one or more users, perform routing to the nodes in which data of the one or more users is stored,
wherein the nodes include a first node for retaining master data of the one or more users, a second node for retaining slave data obtained by replicating the master data, and a third node, and
wherein the routing manager further performs data movement processing involving changing the slave data retained in the second node into the master data, also replicating the slave data, and causing the third node to retain the replicated slave data as new slave data.

2. The data processing system according to claim 1,
wherein the routing manager performs the data movement processing in a case where the first node is not available.

3. The data processing system according to claim 2,
wherein, in a case where routing to the first node is not performed in response to an access request from the one or more users, the routing manager performs alternative routing to the second node and also performs the data movement processing.

4. The data processing system according to claim 3,
wherein, in a case where the routing to the first node is performed in response to an access request from the one or more users, the routing manager inspects the second node, and in a case Where it is found by the inspection that the second node is not available, the routing manager performs processing involving replicating the master data retained in the first node and causing the third node to retain the replicated master data as new slave data.

5. The data processing system according to claim 2,
wherein the routing manager finds that the first node is not available by regularly inspecting the nodes.

6. The data processing system according to claim 1,
wherein the routing manager performs the data movement processing in accordance with loads which the one or more users apply to the nodes.

7. The data processing system according to claim 6,
wherein the routing manager performs the data movement processing in a case where a load applied to the first node is higher than a load applied to the second node.

8. The data processing system according to claim 1,
wherein, for another one or more users different from the one or more users, the first node retains the slave data.

9. The data processing system according to claim 1,
wherein, for another one or more users different from the one or more users, the second node retains the master data.

10. The data processing system according to claim 1,
wherein, for another one or more users different from the one or more users, the third node retains the master data or the slave data.

11. The data processing system according to claim 1,
wherein the third node is selected from the nodes during the data movement processing.

12. The data processing system according to claim 1,
wherein the first node, the second node, and the third node form a node group,
wherein the data processing system includes a plurality of the node groups for retaining a plurality of types of the data, and
wherein the routing manager performs routing by selecting any one of the plurality of node groups in accordance with a type of the data.

13. The data processing system according to claim 1,
wherein the nodes include a server device.

14. The data processing system according to claim 1,
wherein the nodes include a client device.

15. A data processing apparatus comprising:
a storage configured to retain slave data obtained by replicating master data. used for providing one or more users with a service; and
a controller configured to, when a routing manager, which performs routing in response to an access request to the master data, changes the slave data into the master data, accept access to the master data obtained by the change, also replicate the master data obtained by the change. and cause an external device to retain the replicated master data as new slave data.

16. The data processing apparatus according to claim 15,
wherein, for another one or more users different from the one or more users, the storage retains the master data.

17. The data processing apparatus according to claim 15,
wherein, for another one or more users different from the one or more users, the storage does not retain the master data and does not retain the slave data.

18. The data processing apparatus according to claim 15,
wherein the data processing apparatus is a server device.

19. The data processing apparatus according to claim 15,
wherein the data processing apparatus is a client device.

20. A non-transitory computer-readable storage medium having a program retained therein for causing a computer to achieve a function, the computer being connected to a storage retaining slave data obtained by replicating master data used for providing one or more users with a service,
the function including, when a routing manager, which performs routing in response to an access request to the master data, changes the slave data into the master data, accepting access to the master data obtained by the change, also replicating the master data obtained by the change, and causing an external device to retain the replicated master data. as new slave data.
